(19) United States
(12) Patent Application Publication
(10) Pub. No.: US 2013/0239933 A1
(43) Pub. Date: Sep. 19, 2013

(54) TWO-CYCLE ENGINE

(71) Applicant: MARUYAMA MFG. CO., INC., Tokyo (JP)

(72) Inventor: Terutaka Yasuda, Tokyo (JP)

(73) Assignee: Maruyama Mfg. Co., Inc., Tokyo (JP)

(21) Appl. No.: 13/798,611

(22) Filed: Mar. 13, 2013

(30) Foreign Application Priority Data
Mar. 13, 2012 (JP) P2012-056074

(51) Int. Cl. F02B 75/02

(52) U.S. Cl. CPC F02B 75/02
USPC 123/65 R

(57) ABSTRACT

A pair of suction-side scavenging ports introduces a working gas containing fuel into a combustion chamber, and the working gases are caused to collide with each other to thereby form a working gas layer in a state of two vortexes rotating in opposite directions to each other, and a pair of exhaust-side scavenging ports introduces a non-working gas having a lower fuel content rate than the working gas into the combustion chamber, and the non-working gases are caused to collide with each other to thereby form a non-working gas layer in a state of one vortex.

### CROSS-REFERENCE TO RELATED APPLICATIONS

The disclosure of Japanese Patent Application No. JP2012-056074 filed on Mar. 13, 2012 including the specification, drawings and abstract is incorporated herein by reference in its entirety.

### BACKGROUND OF THE INVENTION

1. Field of the Invention

The present invention relates to a two-cycle engine.

2. Related Background of the Invention

Until now, as a two-cycle engine, there has been known, for example, a two-cycle engine set forth in Patent Literature 1. This two-cycle engine is the two-cycle engine of a type in which only one set of a pair of scavenging ports is provided, and a pair of scavenging passages for introducing, into a cylinder, an air-fuel mixture (fresh air gas) in which fuel and air have been mixed is symmetrically arranged with respect to a line connecting a suction port and an exhaust port.

In addition, in Patent Literature 2, there is set forth a two-cycle engine of a type in which two sets of a pair of scavenging ports are provided. This two-cycle engine employs a structure intended, as one of objects, to reduce escape of fresh air gas (working gas) containing fuel from an exhaust port without going through a combustion stroke in a scavenging process, so-called blow.

Specifically, in the two-cycle engine in Patent Literature 2, a suction port and the exhaust port are arranged at positions spaced apart by 180 degrees in a circumferential direction of a cylinder (combustion chamber). Inside a cylinder block, there are formed a pair of scavenging passages (suction-side scavenging ports) opened to a combustion chamber, and a pair of scavenging filling chambers (exhaust-side scavenging ports) opened to the combustion chamber. The pair of scavenging passages is symmetrically arranged with respect to a line connecting the suction port and the exhaust port, the pair of scavenging filling chambers is symmetrically arranged similarly with respect to the above-described line, and the scavenging filling chamber is arranged closer to the exhaust port side than the scavenging passage. An end (end on one side) closer to a bottom dead center of the scavenging passage is opened to a crank chamber, while an end (end on one side) closer to the bottom dead center of the scavenging filling chamber is sealed by a gasket. The adjacent scavenging passage and scavenging filling chamber are formed, separated by a partition, and a communication hole that causes the scavenging passage and the scavenging filling chamber to communicate with each other is formed in the partition. In a piston, near a top dead center, there is provided a communication passage that causes the exhaust port and the scavenging filling chamber to communicate with each other.

In this two-cycle engine in Patent Literature 2, when the piston moves near the top dead center, the exhaust port and the scavenging filling chamber are caused to communicate with each other by the communication passage. At this time, a positive pressure from an exhaust system acts on the scavenging filling chamber via the exhaust port from a communication passage side, and also a negative pressure in the crank chamber acts thereon from a communication hole side. As a result, the working gas that has existed in the scavenging filling chamber is discharged to a scavenging passage side via the communication hole, and also the scavenging filling chamber is filled with exhaust gas (non-working gas) from the exhaust port. Subsequently, when the piston moves from the top dead center to the bottom dead center, the working gas is introduced into the combustion chamber from the scavenging passage, a working gas layer is formed, and also the non-working gas is introduced into the combustion chamber from the scavenging filling chamber, a non-working gas layer is formed, and scavenging is performed. In this case, movement of the working gas to the exhaust port side is suppressed by the non-working gas layer formed on the exhaust port side, and thus blow of the working gas is reduced.
[Patent Literature 1] Japanese Utility Model Application Laid-Open Publication No. 04-19622
[Patent Literature 2] Japanese Patent Application Laid-Open Publication No. 2005-233087,

### SUMMARY OF THE INVENTION

As to the two-cycle engine as mentioned above, development of a technology that can further suppress the blow has been desired.

The present invention has been caused to solve such a problem, and aims at providing a two-cycle engine that can suitably suppress blow.

A two-cycle engine (100) according to one aspect of the present invention is the two-cycle engine (100) including in a cylinder block (1): a combustion chamber (2); a suction port (3) that communicates with the combustion chamber (2); an exhaust port (4) that communicates with the combustion chamber (2), and is arranged so as to face the suction port (3) in a radial direction of the combustion chamber (2); a pair of suction-side scavenging ports (5a, 5b) that communicates with the combustion chamber (2) and also communicates with a crank chamber, and is arranged spaced apart from each other in a circumferential direction of the combustion chamber (2); and a pair of exhaust-side scavenging ports (6a, 6b) that communicates with the combustion chamber (2), and is also arranged spaced apart from each other in the circumferential direction of the combustion chamber (2), the pair of exhaust-side scavenging ports (6a, 6b) being arranged closer to the exhaust port (4) than the suction-side scavenging ports (5a, 5b), wherein the pair of suction-side scavenging ports (5a, 5b) introduces a working gas containing fuel into the combustion chamber (2), and the working gases are caused to collide with each other to thereby form a working gas layer in a state of two vortexes rotating in opposite directions to each other, wherein the pair of exhaust-side scavenging ports (6a, 6b) introduces a non-working gas having a lower fuel content rate than the working gas into the combustion chamber (2), and the non-working gases are caused to collide with each other to thereby form a non-working gas layer in a state of one vortex, and wherein the non-working gas layer is formed by at least either one of a flow rate and a flow velocity of the non-working gas in one exhaust-side scavenging port (6a) of the pair of exhaust-side scavenging ports (6a, 6b) being set larger than that in the other exhaust-side scavenging port (6b) of the pair of exhaust-side scavenging ports (6a, 6b).

In addition, a two-cycle engine (100) according to another aspect of the present invention is the two-cycle engine (100) including in a cylinder block (1): a combustion chamber (2); a suction port (3) that communicates with the combustion chamber (2); an exhaust port (4) that communicates with the combustion chamber (2), and is arranged so as to face the suction port (3) in a radial direction of the combustion chamber (2); a pair of suction-side scavenging ports (5a, 5b) that communicates with the combustion chamber (2) and also communicates with a crank chamber, and is arranged spaced apart from each other in a circumferential direction of the combustion chamber (2); and a pair of exhaust-side scavenging ports (6a, 6b) that communicates with the combustion chamber (2), and is also arranged spaced apart from each other in the circumferential direction of the combustion chamber (2), the pair of exhaust-side scavenging ports (6a, 6b) being arranged closer to the exhaust port (4) than the suction-side scavenging ports (5a, 5b), wherein the pair of suction-side scavenging ports (5a, 5b) introduces a working gas containing fuel into the combustion chamber (2), and the working gases are caused to collide with each other to thereby form a working gas layer in a state of two vortexes rotating in opposite directions to each other, wherein the pair of exhaust-side scavenging ports (6a, 6b) introduces a non-working gas having a lower fuel content rate than the working gas into the combustion chamber (2), and the non-working gases are caused to collide with each other to thereby form a non-working gas layer in a state of one vortex, and wherein the non-working gas layer is formed by a collision angle of the non-working gas in one exhaust-side scavenging port (6a) of the pair of exhaust-side scavenging ports (6a, 6b) being set smaller than that in the other exhaust-side scavenging port (6b) of the pair of exhaust-side scavenging ports (6a, 6b).

In these two-cycle engines according to the aspect of the present invention, a working gas layer in a state of two vortexes (in a state of inverted vortexes) is formed by the pair of suction-side scavenging ports (5a, 5b), and also a non-working gas layer in a state of one vortex (in a state of one rotating vortex in a horizontal direction, in a state of swirl) is formed by the pair of exhaust-side scavenging ports (6a, 6b) formed closer to the exhaust port (4) than the pair of suction-side scavenging ports (5a, 5b). Accordingly, a working gas is prevented from escaping from the exhaust port (4) by the non-working gas layer formed on the exhaust port (4) side. Therefore, blow can be suitably prevented. In addition, since the working gas layer in a state of inverted vortexes and the non-working gas layer in a state of swirl are different flows from each other, respectively, the working gas layer and the non-working gas layer become hard to be mixed. Consequently, the mixing of the working gas with the non-working gas to escape from the exhaust port (4) together with the non-working gas is prevented, and as a result, blow can be more suitably prevented.

Here, in an axis line (A) direction of the combustion chamber (2), when an edge on a top dead center side of one exhaust-side scavenging port (6a) is formed at a position closer to a top dead center than an edge on the top dead center side of the other exhaust-side scavenging port (6b), and thus the flow rate of the non-working gas in the one exhaust-side scavenging port (6a) is set larger than that in the other exhaust-side scavenging port (6b), or when an opening (61a) to the combustion chamber (2) of the one exhaust-side scavenging port (6a) is set smaller than an opening (61b) to the combustion chamber (2) of the other exhaust-side scavenging port (6b), and thus the flow velocity of the non-working gas in the one exhaust-side scavenging port (6a) is set larger than that in the other exhaust-side scavenging port (6b), a swirl can be suitably generated with a simple configuration.

According to the aspect of the present invention, it becomes possible to provide a two-cycle engine in which blow can be suitably suppressed.

### BRIEF DESCRIPTION OF THE DRAWINGS

FIG. 1 is a cross-sectional view of a cylinder block of an embodiment according to a two-cycle engine of the present invention;

FIG. 2 is a cross-sectional view taken along a line II-II in FIG. 1;

FIG. 3 is a cross-sectional view taken along a line in FIG. 2;

FIG. 4 is a cross-sectional view showing the cylinder block of FIG. 3 together with a piston;

FIGS. 5A to 5D are cross-sectional views showing a flow of a scavenging process in the two-cycle engine of FIG. 1;

FIGS. 6A to 6D are cross-sectional views showing a flow subsequent to FIGS. 5A to 5D;

FIG. 7 is a graph showing a relation between a fuel flow rate and THC; and

FIG. 8 is a graph showing a relation between a fuel flow rate and an output.

### DESCRIPTION OF THE PREFERRED EMBODIMENTS

Hereinafter, there will be described in detail an embodiment according to a two-cycle engine of the present invention with reference to the drawings.

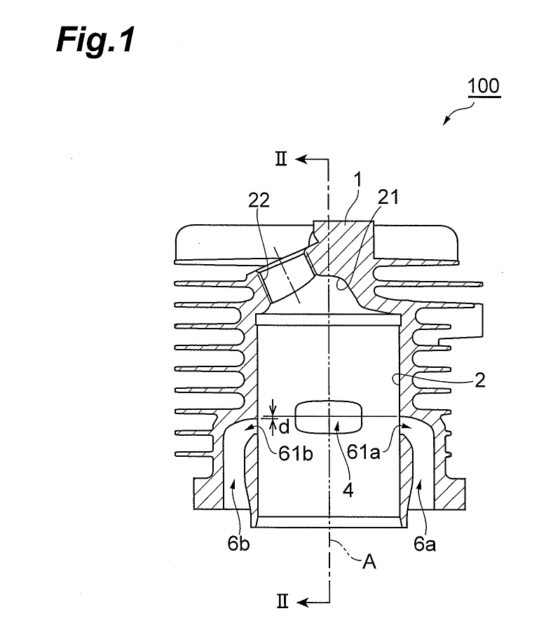

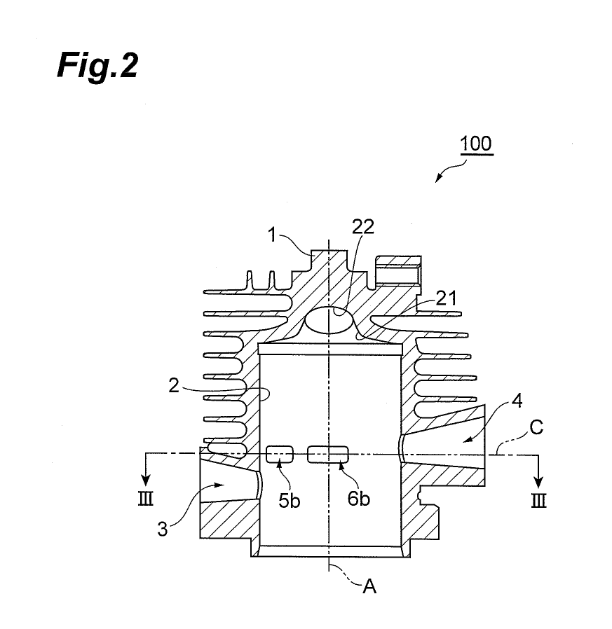

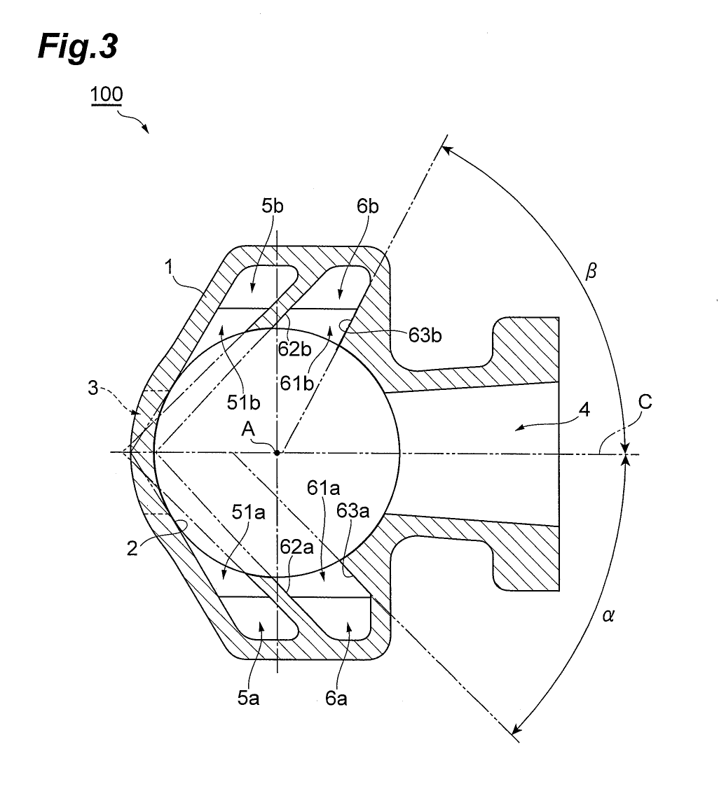

FIG. 1 is a cross-sectional view of a cylinder block of the embodiment according to the two-cycle engine of the present invention, FIG. 2 is a cross-sectional view taken along a line II-II in FIG. 1, and FIG. 3 is a cross-sectional view taken along a line in FIG. 2.

As shown in FIGS. 1 to 3, an engine (a two-cycle engine) 100 is the two-cycle engine that has employed a Schnuerle system as a scavenging method, and, for example, a brushcutter, a backpack power spreader, and the like are equipped with the two-cycle engine. In the engine 100, a combustion chamber 2, a suction port 3, an exhaust port 4, a pair of suction-side scavenging ports 5a and 5b, and a pair of exhaust-side scavenging ports 6a and 6b are formed in a cylinder block 1.

The combustion chamber 2 presents a substantially circular inner surface, and extends, in the cylinder block 1, along an axis line A direction.

As shown in FIGS. 1 and 2, a bottom dead center side (lower sides in the drawings) of the combustion chamber 2 is opened, and the combustion chamber 2 is caused to communicate with a crank chamber that is not shown. A hollow 21 is formed at an end on a top dead center side of the combustion chamber 2, and a discharge electrode such as a spark plug that is not shown, is arranged inside the hollow 21. It is to be noted that in the hollow 21, there is provided a spark plug attachment hole 22 that communicates with an outside of the cylinder block 1, and to which the spark plug is attached.

The suction port 3 and the exhaust port 4 are, as shown in FIGS. 1 to 3, respectively caused to communicate with the combustion chamber 2, and the exhaust port 4 is arranged slightly closer to a top dead center than the suction port 3 in the axis line A direction. The suction port 3 and the exhaust port 4 are arranged displaced to each other in a circumferential direction of the combustion chamber 2 by approximately 180 degrees so as to face each other in a radial direction of the combustion chamber 2. A line connecting the suction port 3 and the exhaust port 4 in the radial direction is set as an imaginary line C.

The suction-side scavenging ports 5a and 5b are the ports for introducing fresh air gas (working gas) containing fuel into the combustion chamber 2 in a scavenging process, and extend inside a side wall of the cylinder block 1 along the axis line A direction. Ends on the top dead center side of the suction-side scavenging ports 5a and 5b respectively communicate with the combustion chamber 2 at substantially similar positions to the exhaust port 4 in the axis line A direction, and the ends are, as shown in FIG. 3, set as suction-side scavenging openings 51a and 51b, respectively. These suction-side scavenging openings 51a and 51b are arranged substantially line-symmetrically with the imaginary line C being set as an axis of symmetry, and are provided so as to form an acute angle with the imaginary line C so that the fresh air gas introduced into the combustion chamber 2 goes closer to the suction port 3. Ends on the bottom dead center side of the suction-side scavenging ports 5a and 5b are caused to communicate with the above-mentioned crank chamber.

Returning to FIGS. 1 and 2, the exhaust-side scavenging ports 6a and 6b are the ports for introducing, into the combustion chamber 2, EGR gas (non-working gas) that is exhaust gas after combustion, having a lower fuel content rate than the working gas in the scavenging process, and extend inside the side wall of the cylinder block 1 along the axis line A direction. Ends on the top dead center side of the exhaust-side scavenging ports 6a and 6b respectively communicate with the combustion chamber 2 at substantially similar positions to the exhaust port 4 in the axis line A direction, and the positions are set as exhaust-side scavenging openings 61a and 61b, respectively. Here, as shown in FIG. 1, an edge on the top dead center side of one exhaust-side scavenging opening 61a is formed at a position closer to the top dead center by a distance d than an edge on the top dead center side of the other exhaust-side scavenging opening 61b.

As shown in FIG. 3, the exhaust-side scavenging openings 61a and 61b are asymmetrically provided with the imaginary line C being set as the axis, and are provided so as to form an acute angle with the imaginary line C so that the EGR gas introduced into the combustion chamber 2 goes closer to the suction port 3. More specifically, an inner wall 62a on a suction port 3 side of the one exhaust-side scavenging opening 61a, and an inner wall 62b on the suction port 3 side of the other exhaust-side scavenging opening 61b are here provided substantially line-symmetrically with the imaginary line C being set as the axis of symmetry, and respectively form an acute angle with the imaginary line C. Meanwhile, an inner wall 63a on an exhaust port 4 side of the one exhaust-side scavenging opening 61a, and an inner wall 63b on the exhaust port 4 side of the other exhaust-side scavenging opening 61b are here asymmetrically provided with the imaginary line C being set as the axis. When described in detail, an angle α formed by one inner wall 63a and the imaginary line C, and an angle β formed by the other inner wall 63b and the imaginary line C are both set as acute angles, and the angle α is set smaller than the angle β. With such a configuration, a collision angle of the EGR gas from the one exhaust-side scavenging port 6a is set smaller than a collision angle of the EGR gas from the other exhaust-side scavenging port 6b. It is to be noted that a collision angle means an angle that the imaginary line (imaginary line C) connecting a suction port and an exhaust port, and a gas flow from each scavenging port form with each other, when gases introduced into a combustion chamber from the pair of scavenging ports, respectively collide with each other.

In the one exhaust-side scavenging opening 61a, the inner wall 62a on the suction port 3 side and the inner wall 63a on the exhaust port 4 side are provided substantially in parallel with each other. Meanwhile, in the other exhaust-side scavenging opening 61b, the inner wall 62b on the suction port 3 side and the inner wall 63b on the exhaust port 4 side are provided so as to separate from each other toward the combustion chamber 2. That is, the one exhaust-side scavenging opening 61a is set smaller than the other exhaust-side scavenging opening 61b. As a result, a gas flow from the one exhaust-side scavenging opening 61a is introduced into the combustion chamber 2 in a state of maintaining a force as compared with a gas flow from the other exhaust-side scavenging opening 61b, and a flow velocity of the gas flow from the one exhaust-side scavenging opening 61a is set larger.

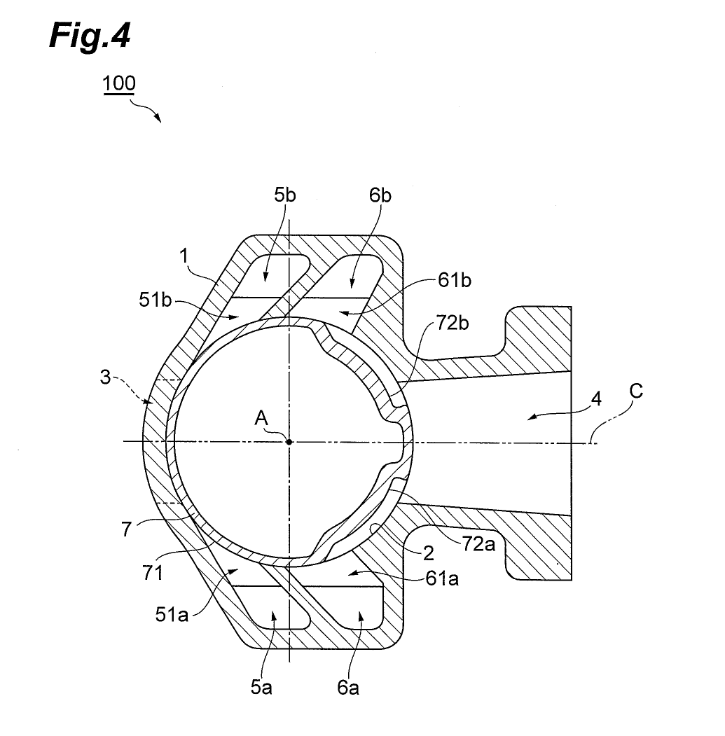

FIG. 4 is a cross-sectional view showing the cylinder block of FIG. 3 together with a piston, and is the cross-sectional view in a state where a piston 7 is located near the top dead center. As shown in FIG. 4, in the piston 7, a pair of groove portions 72a and 72b along a circumferential direction is provided in a sliding contact surface 71 that is slidingly in contact with the combustion chamber 2. These groove portions 72a and 72b are the groove portions for causing the exhaust port 4 and each of the exhaust-side scavenging ports 6a and 6b to communicate with each other, when the piston 7 is located near the top dead center, they are arranged substantially line-symmetrically with the imaginary line C being set as the axis of symmetry, and are formed so as to straddle the exhaust port 4 and each of the exhaust-side scavenging openings 61a and 61b.

Next, operation of the engine 100 will be described.

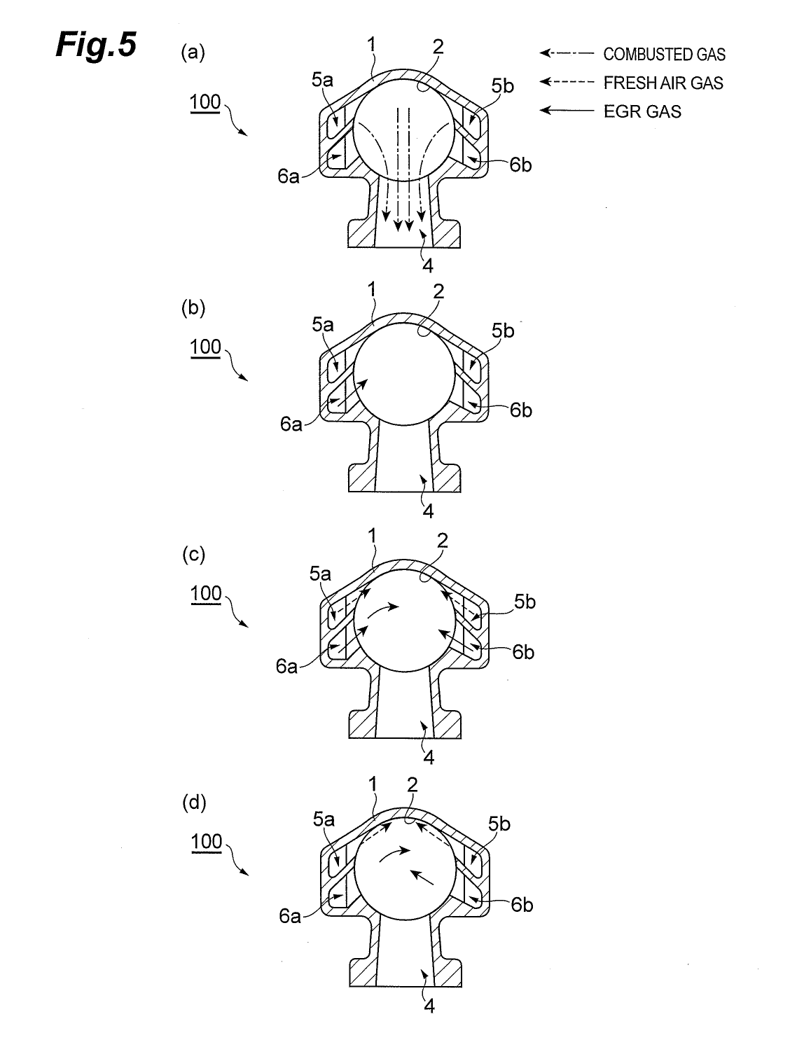

FIGS. 5A to 5D are cross-sectional views showing a flow of the scavenging process in the two-cycle engine of FIG. 1, FIG. 5A is a cross-sectional view showing a state where an exhaust port communicates with a combustion chamber, FIG. 5B is a cross-sectional view showing a state where one exhaust-side scavenging port communicates with the combustion chamber, FIG. 5C is a cross-sectional view showing a state where all scavenging ports communicate with the combustion chamber, and FIG. 5D is a cross-sectional view showing a state where a piston is located at a bottom dead center.

In the engine 100, first, near the top dead center, the exhaust port 4 and each of the exhaust-side scavenging ports 6a and 6b are caused to communicate with each other by the groove portions 72a and 72b of the piston 7, and the exhaust-side scavenging ports 6a and 6b are respectively filled with EGR gas via the groove portions 72a and 72b from the exhaust port 4.

Next, as shown in FIG. 5A, when the piston 7 moves from the top dead center toward the bottom dead center, the exhaust port 4 is caused to communicate with the combustion chamber 2, and combusted gas in the combustion chamber 2 is exhausted from the exhaust port 4.

Subsequently, as shown in FIG. 5B, when the piston 7 further moves to the bottom dead center side, one exhaust-side scavenging port 6a opened to the top dead center side as compared with the other scavenging ports is caused to communicate with the combustion chamber 2 (refer to FIG. 1), and the EGR gas with which the exhaust-side scavenging port 6a has been filled is introduced into the combustion chamber 2.

Then, as shown in FIG. 5C, when the piston 7 further moves to the bottom dead center side, the other exhaust-side scavenging port 6b is caused to communicate with the combustion chamber 2, the EGR gas with which the exhaust-side scavenging port 6b has been filled is introduced into the combustion chamber 2, also the suction-side scavenging ports 5a and 5b are respectively caused to communicate with the combustion chamber 2, and fresh air gas is introduced into the combustion chamber 2.

Subsequently, as shown in FIG. 5D, when the piston 7 moves to the bottom dead center, introduction of scavenging gas (EGR gas, fresh air gas) to the combustion chamber 2 is completed. In this case, as mentioned above, the one exhaust-side scavenging port 6a is caused to communicate with the combustion chamber 2 sooner than the other exhaust-side scavenging port 6b, and thus a flow rate of the EGR gas from the one exhaust-side scavenging port 6a is larger than a flow rate of the EGR gas from the other exhaust-side scavenging port 6b. In addition, as mentioned above, the EGR gas from the one exhaust-side scavenging port 6a is introduced into the combustion chamber 2 in a state of maintaining a force as compared with the EGR gas from the other exhaust-side scavenging port 6b, and thus a flow velocity of the EGR gas from the one exhaust-side scavenging port 6a becomes larger. Furthermore, the EGR gas having a small collision angle, introduced from the one exhaust-side scavenging port 6a into the combustion chamber 2 is likely to cause a flow along a circumferential direction of an inner wall of the combustion chamber 2, as compared with the EGR gas having a large collision angle, introduced from the other exhaust-side scavenging port 6b into the combustion chamber 2.

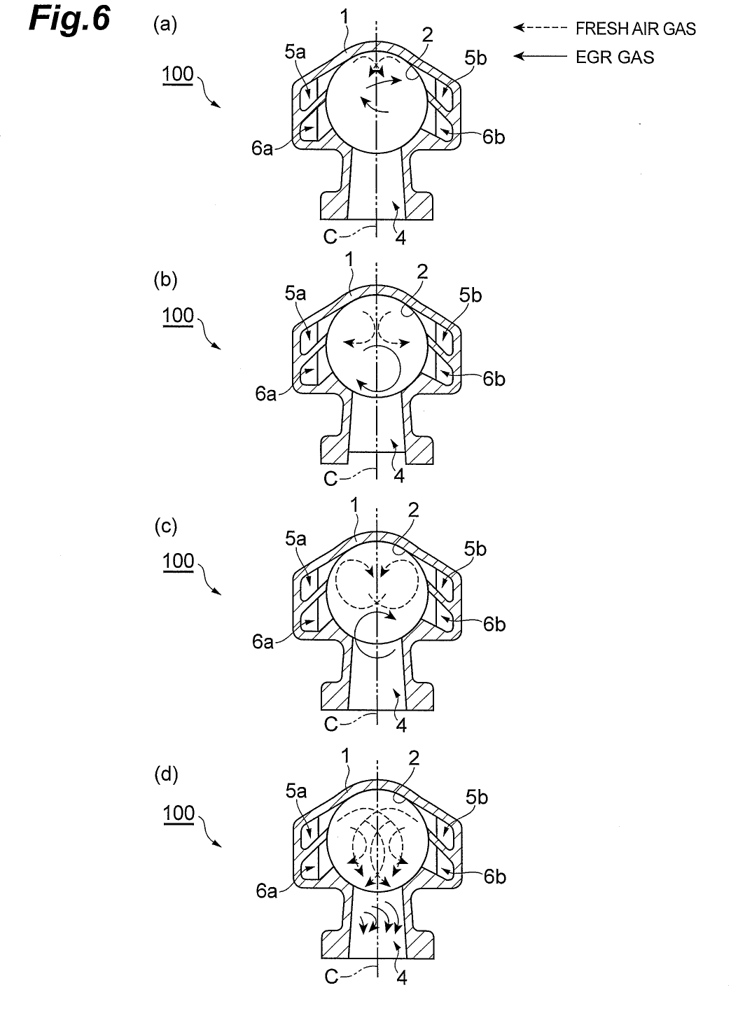

FIGS. 6A to 6D are cross-sectional views showing a flow subsequent to FIGS. 5A to 5D, FIG. 6A is a cross-sectional view showing a state where the respective scavenging gases collide with each other, FIG. 6B is a cross-sectional view showing a state where inverted vortexes by working gas and a swirl by non-working gas are generated, FIG. 6C is a cross-sectional view showing a state where a non-working gas layer blows out, and FIG. 6D is a cross-sectional view showing a state where an exhaust port is closed.

As shown in FIG. 6A, when the respective scavenging gases reach near the imaginary line C, fresh air gases from the suction-side scavenging ports 5a and 5b collide with each other, and also EGR gases from the exhaust-side scavenging ports 6a and 6b collide with each other.

Subsequently, as shown in FIG. 6B, the fresh air gases which have been introduced from the suction-side scavenging ports 5a and 5b that are substantially line-symmetric with the imaginary line C being set as the axis of symmetry and which have collided with each other invert respectively since the flow rates and flow velocities thereof are substantially similar to each other, and two vortexes (inverted vortexes) rotating in opposite directions to each other are generated. In a manner described above, a fresh air gas layer in a state of inverted vortexes by the fresh air gas is generated.

Meanwhile, as to the EGR gases which have been introduced from the exhaust-side scavenging ports 6a and 6b that are asymmetric with the imaginary line C being set as the axis and which have collided with each other is, as mentioned above, the flow rate and the flow velocity of the EGR gas from the one exhaust-side scavenging port 6a are larger than those of the EGR gas from the other exhaust-side scavenging port 6b, and a flow of the EGR gas from the one exhaust-side scavenging port 6a is the flow along the circumferential direction of the inner wall of the combustion chamber 2, and thus the EGR gas from the one exhaust-side scavenging port 6a surpasses the EGR gas from the other exhaust-side scavenging port 6b, these EGR gases join together, and one vortex (rotating vortex in a horizontal direction, swirl) is generated. In a manner described above, an EGR gas layer in a state of swirl by the EGR gas is generated.

As described above, in the engine 100, while the fresh air gas layer in a state of inverted vortexes is generated by the fresh air gas from the suction-side scavenging ports 5a and 5b, the EGR gas layer in a state of swirl with a different flow from the inverted vortexes is generated by the EGR gas from the exhaust-side scavenging ports 6a and 6b, and thus the fresh air gas layer and the EGR gas layer become hard to be mixed. In addition, since the EGR gas layer in a state of swirl is generated on the exhaust port (4) side, this EGR gas layer in a state of swirl serves as a barrier, and the fresh air gas from the suction-side scavenging ports 5a and 5b is suitably prevented from escaping from the exhaust port 4.

Subsequently, as shown in FIG. 6C, the EGR gas layer suitably blows out of the exhaust port 4 along with the expansion of the fresh air gas layer.

Next, as shown in FIG. 6D, the exhaust port 4 is closed with respect to the combustion chamber 2 by the piston 7 that moves from the bottom dead center to the top dead center. In this case, most of the EGR gas layer is suitably blown out of the exhaust port 4, while the EGR gas is hardly mixed in the fresh air gas layer that has stayed in the combustion chamber 2 as mentioned above, and thus the fresh air gas layer is suitably caused to remain in the combustion chamber 2. A next combustion stroke is then carried out in a state where the fresh air gas layer is suitably caused to remain.

As described above, in the engine 100 according to the embodiment, the working gas layer in a state of inverted vortexes is formed by the pair of suction-side scavenging ports 5a and 5b, and also the non-working gas layer in a state of swirl is formed by the pair of exhaust-side scavenging ports 6a and 6b that are formed closer to the exhaust port 4 than the pair of suction-side scavenging ports 5a and 5b. Accordingly, the working gas is prevented from escaping from the exhaust port 4 by the non-working gas layer formed on the exhaust port 4 side, and blow can be suitably prevented.

Here, in a conventional two-cycle engine in which the pair of suction-side scavenging ports 5a and 5b and the pair of exhaust-side scavenging ports 6a and 6b are respectively provided substantially line-symmetrically with respect to the imaginary line C, it is considered that an amount of EGR gas is increased in order to reduce blow of the fresh air gas. However, by just increasing the amount of EGR gas, the fresh air gas and the EGR gas are mixed with each other, the EGR gas remains in the combustion chamber 2 after the exhaust port 4 was closed by the piston 7, and there is a possibility of causing deterioration in a suction efficiency (a rate of a weight of fuel introduced into a combustion chamber in a state where an exhaust port is closed, to a weight of fuel supplied to an engine). In addition, when the next combustion stroke is carried out in a state where the EGR gas remains in the combustion chamber 2 after the exhaust port 4 was closed as described above, there is a possibility of causing deterioration in an engine output due to deterioration in a suction ratio (a rate of the weight of fuel supplied to the engine to a weight of air for a stroke volume).

In contrast to this, in the engine 100 according to the embodiment, as mentioned above, the fresh air gas layer in a state of inverted vortexes by the fresh air gas from the suction-side scavenging ports 5a and 5b, and the EGR gas layer in a state of swirl by the EGR gas from the exhaust-side scavenging ports 6a and 6b have different flows from each other, and thus the fresh air gas layer and the EGR gas layer are hard to be mixed with each other, and the EGR gas is prevented from remaining in the combustion chamber 2, after the exhaust port 4 was closed by the piston 7. Accordingly, deterioration in the suction efficiency and deterioration in the engine output can be suppressed. In addition, since in the engine 100, the fresh air gas layer and the EGR gas layer are hard to be mixed with each other in this way, the mixing of the fresh air gas with the EGR gas to escape from the exhaust port 4 together with the EGR gas is prevented, and blow can be more suitably prevented.

Furthermore, in the engine 100, the collision angle of the non-working gas in the one exhaust-side scavenging port 6a is set smaller than that in the other exhaust-side scavenging port 6b of the pair of exhaust-side scavenging ports 6a and 6b, whereby the EGR gas from the one exhaust-side scavenging port 6a serves as a flow along the inner wall of the combustion chamber 2 as compared with the EGR gas from the exhaust-side scavenging port 6b, and as a result, an EGR gas layer in a state of swirl is formed. A swirl can be suitably generated with such a simple configuration.

Moreover, in the engine 100, in the axis line A direction of the combustion chamber 2, the edge on the top dead center side of the one exhaust-side scavenging port 6a is formed at the position closer to the top dead center than the edge on the top dead center side of the other exhaust-side scavenging port 6b, whereby the flow rate of the EGR gas from the one exhaust-side scavenging port 6a is larger than the flow rate of the EGR gas from the other exhaust-side scavenging port 6b, and thus an EGR gas layer in a state of swirl is formed. A swirl can be suitably generated even with such a simple configuration.

In addition, in the engine 100, the one exhaust-side scavenging opening 61a is set smaller than the other exhaust-side scavenging opening 61b, whereby the flow velocity of the EGR gas from the one exhaust-side scavenging port 6a is larger as compared with the flow velocity of the EGR gas from the other exhaust-side scavenging port 6b, and thus an EGR gas layer in a state of swirl is formed. A swirl can be suitably generated even with such a simple configuration.

Next, there will be described results of experiments for confirming effects of the engine 100 according to the present embodiment.

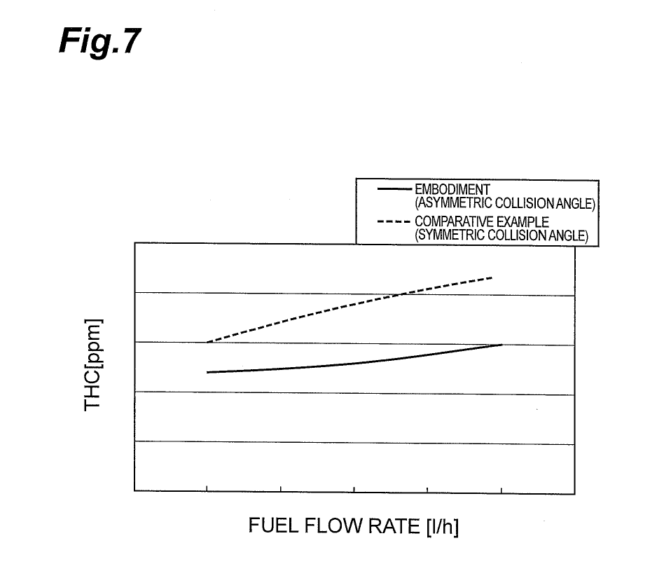

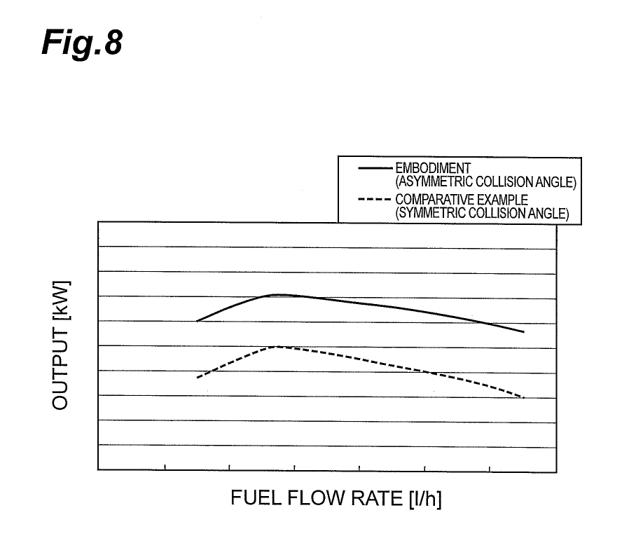

FIG. 7 is a graph showing a relation between a fuel flow rate (flow rate of fuel supplied to an engine) and THC, and FIG. 8 is a graph showing a relation between a fuel flow rate and an output. Solid lines in FIGS. 7 and 8 show results of the two-cycle engine in which the exhaust-side scavenging ports 6a and 6b are asymmetrically provided with the imaginary line C being set as the axis as in the case of the engine 100 according to the embodiment. In addition, broken lines in FIGS. 7 and 8 show results of the two-cycle engine in which the exhaust-side scavenging ports 6a and 6b are symmetrically provided with the imaginary line C being set as the axis of symmetry as in the case of the conventional two-cycle engine.

As shown in FIG. 7, in the engine 100 according to the present embodiment, THC can be suitably reduced as compared with the conventional two-cycle engine.

In addition, as shown in FIG. 8, in the engine 100 according to the present embodiment, the engine output can be suitably increased as compared with the conventional two-cycle engine.

Hereinbefore, although the embodiment according to the two-cycle engine of the present invention has been described, the present invention is not limited to the above-described embodiment. For example, although the above-described embodiment is configured such that the exhaust-side scavenging ports 6a and 6b are caused to communicate with the exhaust port 4 by the groove portions 72a and 72b of the piston 7 near the top dead center to thereby be filled with the EGR gas, and such that the EGR gas is introduced into the combustion chamber 2 in the scavenging process, the present invention is not limited to such a configuration. For example, the present invention may be configured such that an air passage that communicates with an external air space is provided in the cylinder block 1, such that the exhaust-side scavenging ports 6a and 6b are caused to communicate with the air passage by the groove portions 72a and 72b near the top dead center to thereby be filled with the air, and such that gas containing the air and having a lower fuel content rate than the fresh air gas is introduced into the combustion chamber 2 in the scavenging process.

In addition, although in the above-described embodiment, both the flow rate and the flow velocity of the EGR gas in the one exhaust-side scavenging port 6a are set larger than those in the other exhaust-side scavenging port 6b, at least either one may just be set larger. Furthermore, it is not always necessary that the collision angle of the EGR gas in the one exhaust-side scavenging port 6a is set smaller than that in the other exhaust-side scavenging port 6b. In short, the EGR gas from the one exhaust-side scavenging port 6a surpasses the EGR gas from the other exhaust-side scavenging port 6b, and a swirl may just be generated.

In addition, values of the collision angles α and β of the exhaust-side scavenging ports 6a and 6b can be appropriately changed on the basis of a flow velocity of the gas, a diameter (cylinder bore diameter) of the combustion chamber 2, and the like.

1. cylinder block 2. combustion chamber 3. suction port 4. exhaust port 5a, 5b. suction-side scavenging port 6a, 6b. exhaust-side scavenging port 100. engine (2-cycle engine)

What is claimed is:

1. A two-cycle engine comprising in a cylinder block: a combustion chamber; a suction port that communicates with the combustion chamber; an exhaust port that communicates with the combustion chamber, and is arranged so as to face the suction port in a radial direction of the combustion chamber; a pair of suction-side scavenging ports that communicates with the combustion chamber and also communicates with a crank chamber, and is arranged spaced apart from each other in a circumferential direction of the combustion chamber; and a pair of exhaust-side scavenging ports that communicates with the combustion chamber, and is also arranged spaced apart from each other in the circumferential direction of the combustion chamber, the pair of exhaust-side scavenging ports being arranged closer to the exhaust port than the suction-side scavenging ports, wherein
the pair of suction-side scavenging ports introduces a working gas containing fuel into the combustion chamber, and the working gases are caused to collide with each other to thereby form a working gas layer in a state of two vortexes rotating in opposite directions to each other, wherein
the pair of exhaust-side scavenging ports introduces a non-working gas having a lower fuel content rate than the working gas into the combustion chamber, and the non-working gases are caused to collide with each other to thereby form a non-working gas layer in a state of one vortex, and wherein
the non-working gas layer is formed by at least either one of a flow rate and a flow velocity of the non-working gas in one exhaust-side scavenging port of the pair of exhaust-side scavenging ports being set larger than that in the other exhaust-side scavenging port of the pair of exhaust-side scavenging ports.

2. The engine according to claim 1, wherein
in an axis line direction of the combustion chamber, an edge on a top dead center side of one exhaust-side scavenging port is formed at a position closer to a top dead center than an edge on the top dead center side of the other exhaust-side scavenging port, and thus the flow rate of the non-working gas in the one exhaust-side scavenging port is set larger than that in the other exhaust-side scavenging port, or wherein
an opening to the combustion chamber of the one exhaust-side scavenging port is set smaller than an opening to the combustion chamber of the other exhaust-side scavenging port, and thus the flow velocity of the non-working gas in the one exhaust-side scavenging port is set larger than that in the other exhaust-side scavenging port.

3. The engine according to claim 1, wherein
in an exhaust-side scavenging opening of one exhaust-side scavenging port, an inner wall on the suction port side and an inner wall on the exhaust port side are provided in parallel with each other, and wherein
in an exhaust-side scavenging opening of other exhaust-side scavenging port, an inner wall on the suction port side and an inner wall on the exhaust port side are provided so as to separate from each other toward the combustion chamber.

4. A two-cycle engine comprising in a cylinder block: a combustion chamber; a suction port that communicates with the combustion chamber; an exhaust port that communicates with the combustion chamber, and is arranged so as to face the suction port in a radial direction of the combustion chamber; a pair of suction-side scavenging ports that communicates with the combustion chamber and also communicates with a crank chamber, and is arranged spaced apart from each other in a circumferential direction of the combustion chamber; and a pair of exhaust-side scavenging ports that communicates with the combustion chamber, and is also arranged spaced apart from each other in the circumferential direction of the combustion chamber, the pair of exhaust-side scavenging ports being arranged closer to the exhaust port than the suction-side scavenging ports, wherein
the pair of suction-side scavenging ports introduces a working gas containing fuel into the combustion chamber, and the working gases are caused to collide with each other to thereby form a working gas layer in a state of two vortexes rotating in opposite directions to each other, wherein
the pair of exhaust-side scavenging ports introduces a non-working gas having a lower fuel content rate than the working gas into the combustion chamber, and the non-working gases are caused to collide with each other to thereby form a non-working gas layer in a state of one vortex, and wherein
the non-working gas layer is formed by a collision angle of the non-working gas in one exhaust-side scavenging port of the pair of exhaust-side scavenging ports being set smaller than that in the other exhaust-side scavenging port of the pair of exhaust-side scavenging ports.

5. The engine according to claim 4, wherein
an inner wall on the suction port side of an exhaust-side scavenging opening of one exhaust-side scavenging port, and an inner wall on the suction port side of an exhaust-side scavenging opening of other exhaust-side scavenging port are provided line-symmetrically with an imaginary line connecting the suction port and the exhaust port in the radial direction, and respectively form an acute angle with the imaginary line, and wherein
an inner wall on the exhaust port side of the exhaust-side scavenging opening of the one exhaust-side scavenging port, and an inner wall on the exhaust port side of the exhaust-side scavenging opening of the other exhaust-side scavenging port are asymmetrically provided with the imaginary line.
